(19) United States
(12) Patent Application Publication
(10) Pub. No.: US 2003/0046179 A1
(43) Pub. Date: Mar. 6, 2003

(54) Vehicle shopping and buying system and method

(76) Inventors: Farid Anabtawi, Novi, MI (US); Luciene Borges Dos Santos, Santo Andre (BR); W. W. Brent Dewar, New York, NY (US); Ana T. Ishikawa, Pinheiros (BR)

Correspondence Address: JEFFREY A. SEDLAR, General Motors Corporation, Legal Staff, Mail Code 482-C23-B21, P.O. Box 300, Detroit, MI, 48265-3000, US

(21) Appl. No.: 09/948,142

(22) Filed: Sep. 6, 2001

(51) Int. Cl. G06F 17/60

(52) U.S. Cl. 705/26

(57) ABSTRACT

A complete internet shopping and buying system allows a customer to configure a vehicle of their choice by selecting options and creating and viewing a graphic model, locate a dealership, select a payment option, locate a specific vehicle and purchase the vehicle. The shopping process is divided into non-sequential phases including general information, a virtual vehicle showroom, a vehicle configurator, a dealership locator and payment options. The buying process is divided into sequential phases including customer profile, vehicle configurator, payment options, vehicle location and reservation, and confirmation.

### TECHNICAL FIELD

This invention relates to a vehicle shopping and buying system and method and more particularly, to a way of providing a complete shopping and buying experience including direct sales to consumers, one price selling, and a customer express delivery system all via the internet.

### BACKGROUND OF THE INVENTION

The following specification describes a shopping and buying process that involves the use of the internet to provide customers with the right vehicle at the right place, at the right time and at the right price. Savvy cybercustomers are making these demands in ever increasing numbers and will appreciate the ease of the shopping and buying experience provided by this invention. They will also understand and appreciate the complexity of the system that makes it all possible. However, for others who are not as well versed in the workings of today's internet and its related components and systems, the following brief synopsis is provided as an aid in understanding the operation and advantages of the present invention.

The internet is an ever evolving collection of countless computers linked together by an enormous network that allows the connected computers to communicate with each other. The software in the individual computers determines whether they understand each other and whether they work together to provide information and services. Therefore, in a correctly operating system the computers are interdependent on each other.

A home or personal computer is usually networked with other computers via the internet by linking through a phone line and modem (or a cable line and cable modem), and communicates through an internet service provider (ISP). Computers used in businesses and other large organizations usually include a network interface card (NIC) that directly connects to a local area network (LAN) inside the business. The entire LAN and its connected computers may then be placed in communication with an ISP using a high speed data line. First line ISP's may be connected to even larger ISP's, with the largest ISP's including transmission lines with massive capacity that serve as a trunkline for a nation or region. The trunklines are connected globally through fiber optic lines, cables and satellite links providing virtually unlimited access globally to all the connected computers that offer an open port.

Managing all the machines communicating via the internet would seem an impossible task. Although communications are sometimes corrupted or unsuccessful, in most cases the management system operates seamlessly. To accomplish the task, each machine on the internet is assigned a unique IP address. IP addresses are 32 bit numbers normally expressed as four octets in a dotted decimal number. A typical IP address can be something like the number: 098.76.54.321. The four numbers in the string address are called octets because they each have values between 0 and 255 (2⁸ possibilities per octet). Every machine on the internet at any given time has a unique IP address, but a computer's IP address isn't necessarily always the same. Typically, a server has a static IP address that does not change very often. However, a personal computer or home machine that connects to the internet through a modem often has an IP address that is assigned by the ISP when the user dials in. In those cases where the IP address is changed, the particular IP address that is used is unique for the particular session on the internet at that particular time. In this way the ISP only needs one IP address for each modem it is actively supporting rather than for every customer. IP addresses are important because they enable the management of communications between users of the internet.

Generally speaking, all of the computers on the internet can be categorized into two types: servers and clients. Those computers that provide services to other computers are known as servers. Those computers that are accessing the computers running such services are known as clients. When a typical web surfer contacts a site on the internet such as GM.com at www.gm.com, a web page is found. GM.com is providing a computer or a multitude of computers, connected to the internet to service the inquiring person's request. As such, GM.com is a server. The computer of the other person is not providing a service on the internet in this situation and is therefore, a client. It is also common for a computer to function both as a server and a client when it performs both roles.

A server machine may provide one or more services on the internet. Clients that come to a server machine do so with a specific intent, so a client's request is directed to a specific server running the software that they want to access. For example, if the client is running a web browser on their machine, it will normally want to communicate with the web browser on the server machine. Similarly, a client's email application wants to communicate with email servers, etc.

Typing in an IP address is a way to initiate communication with a server connected to the internet, but servers on the internet also have an alpha numeric name called a domain name. For example, www.GM.com is a permanent domain name. The domain name has three parts: (1) the host name (www), (2) the domain name (GM) and (3) the top level domain name (corn). Domain names are managed by an organization whose function is to ensure that all domain names within a top level domain name are unique. A set of servers called domain name servers maps the alphanumeric names with the IP addresses. Server computers on the internet open their services using numbered ports, one for each service that is available on the server. Clients connect to a service at a specific IP address and on a specific port number. If the server accepts connections on a port from outside, you can connect to the port from anywhere through the internet and use the service.

To obtain information from a particular web site, the user types the uniform or universal resource locator (URL) into a browser. The browser breaks the URL down into three parts (1) the protocol (“http”), (2) the server name (“www.ISP.com”), and (3) the file name (“web-server.htm”). The browser communicates with the main server to translate the server name into an IP address. The browser then forms a connection to the web server at that IP address on a port. Following the http protocol, the browser sends a request to the server asking for the file. The client and server communicate exchanging information to format the site's web pages on the client's monitor screen.

A web page is a file that contains text along with a set of hyper text markup language (HTML) tags that describe how the text should be formatted when the browser displays it on the screen. The web browser manages the client's request to go to a web server on the internet and requests a page. The web browser also interprets HTML tags within the page to display the page on the client's screen as the page's creator intended it to look. The page often affords the client the opportunity to enter data, which the server manages and initiates responses to the entered data.

Using the internet, clients or potential customers can conduct research, obtain information and actually secure goods or services in a very short time without moving away from their computer. But even now after most businesses have embraced the internet, the traditional process for purchasing an automotive vehicle continues to prevail. That process is usually complicated and very time consuming. In many instances, it may be inconvenient for a customer to drive to multiple locations in search of the right vehicle at the right price. The customer may experience a tremendous lack of access to information concerning pricing, financing, options and vehicle availability. As a result, some customers have developed a general dislike for the process. Many customers are uncomfortable haggling to negotiate for a price they feel is fair for the vehicle they've selected. Notwithstanding, these drawbacks of the traditional process, many vehicle customers prefer to see and test drive a vehicle prior to purchasing it. Thus, it would be desirable to provide a system that gives new vehicle customers access to information concerning pricing, financing, models and options while leveraging the benefits of both the internet and the traditional car buying process.

### SUMMARY OF THE INVENTION

The present invention includes an online vehicle shopping and buying system. According to the present invention, a customer may conduct a search for vehicle data by using the internet to access a web site via the customer's own personal computer or via a computer provided at a vehicle store. The web site facilitates the shopping and buying process by being available 24/7, and manages the customer relationship. Advantageously, the shopping and buying process is subdivided into phases, of which, only some or all may be included in the inventive process defined by the present invention. The phases may include information gathering, information submittal, choice selection and finalizing a purchase. A complete online sales experience is provided if preferred by the customer, where the only necessary offline process is the actual taking delivery of the vehicle. The sales experience includes the ability for the customer to virtually build and accessorize a vehicle of their choice.

According to preferred and optional features of the present invention, after building a desired cyber-configuration of a vehicle, the customer searches for a matching physical unit via the web site. The located vehicle is an actual unit from available stock, or is a wait list unit provided when built, available and fitting the customer's specifications. When the vehicle is available out-of-stock, and the customer has paid a reservation fee or secured financing, the vehicle's identification number (VIN) is associated with the customer's website record. When selecting financing or leasing as the preferred payment type, the necessary credit approval process can take place online. An express application is filled out online with prepopulated data from any personal profile submitted by the customer and additional or absent data is input for required fields. The customer may also use certain types of credit for the reservation fee or even for the entire purchase. There's no need to contact a dealer in the initial stages and no hassle with bargaining for the purchase price. The vehicle is purchased at a fair fixed price, with the customer having the choice of completing the transaction themselves or going to a dealership to be assisted by a sales consultant.

### BRIEF DESCRIPTION OF THE DRAWINGS

FIG. 1 is schematic diagram of a system according to the present invention.

FIG. 2 is a schematic diagram of a system according to the present invention for use with the system of FIG. 1.

FIG. 3 is a schematic diagram of a method according to the present invention for use with the system of FIGS. 1 and 2.

FIG. 4 is a schematic diagram of a method according to the present invention for use with the system of FIGS. 1 and 2.

FIG. 5 is a schematic diagram of a website page according to the system and method of FIGS. 1-4.

### DESCRIPTION OF THE PREFERRED EMBODIMENT

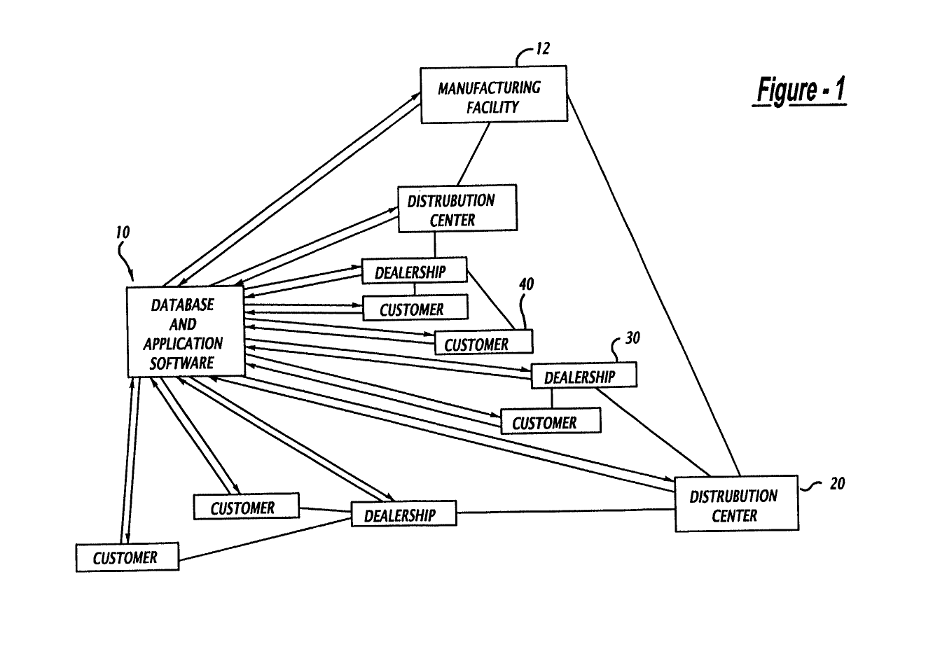

Sales of vehicles under the preferred embodiment of the present invention involve a system and a method that require stepping out of the conventional comfort zone and breaking ground so that customers can have the right vehicle at the right place, at the right time and at the right price. Referring to FIG. 1, the e-commerce based strategy targets a market that is quickly adopting internet technology for the sake of speed, convenience and economy. The strategy hinges on a website 10 that includes a database and application software and that brings together at least one vehicle manufacturing facility 12 with a plurality of distribution centers 20 located regionally, a plurality of dealerships 30 serviced by the distribution centers and a plurality of customer locations 40 serviced by the dealerships. The distribution centers 20 primarily support the speedy fulfillment of internet orders, with the help of interactions with and among the dealerships 30, with ultimate reliance on the vehicle manufacturing facility 12. The website is accessed from kiosks on the showroom floors of the dealerships 30 or from the customer's location 40, when equipped with internet access. Access is typically achieved through a modem, internet service provider and server (not shown). Customers who prefer to physically encounter a vehicle before purchasing it can inspect a comparable vehicle of the same model at the dealership's showroom and purchase the same type of vehicle online, or can choose to complete the transaction at the dealership.

The internet sales channel allows the customer to begin their relationship with the vehicle of their choice even before having physically seen it for the first time. Customers can buy the vehicle they want via the internet at the time they want with the system available 24 hours a day/7 days a week. The customer can also locate and track the vehicle at the dealership 30, at the distribution center 20 or at the manufacturing facility 12. In other words, the client is empowered to the extent that even when the showroom is closed, the manufacturer and dealer can close a sale with the customer.

The website offers a given vehicle at only one price including taxes and delivery. A blanket price facilitates the e-commerce process and allows the dealership to concentrate on the service aspects of the transaction. The website is also directly linked to credit system network allowing for online, real time transaction conclusion.

The customer website has 2 slightly different versions: one for customers accessing from a dealership showroom kiosk and another for customers accessing from home or another location. To set up a dealer kiosk it's necessary to access a specific URL, which brings a log-in page requesting the dealer to insert its own id and password. From then on, anytime the dealer accesses the website, it will bring up the website home page—kiosk version. The main differences between the two versions are the ability to find a dealer (in the kiosk the hosting dealership is defaulted) and the payment options for the home version are slightly more limited.

The website is designed to allow consumers to browse and research information about the available vehicles and/or enter the buying process and complete an online purchase. There is a common navigational scheme used throughout the site to facilitate the shopping and buying processes. The navigation buttons are linked to sections of pages within the site. When a button is selected, the user/customer is brought to the starting page of that section and the button remains highlighted.

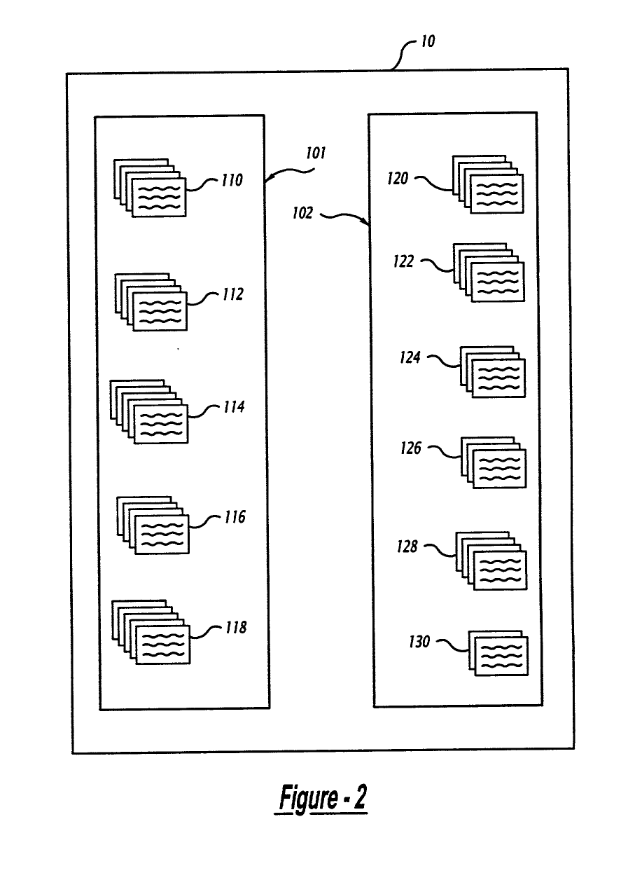

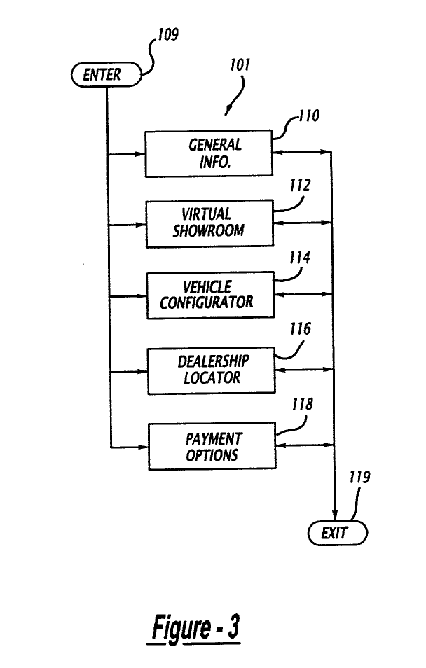

Both the customer and the kiosk versions of the website 10 have basically 2 distinct navigation processes shown in FIG. 2, a shopping process 101 and a buying process 102. During the shopping process 101, the customer is able to choose the path they take as they perform the various shopping functions. The website shopping process 101 is divided in five primary non-sequential phases (areas). As shown in FIG. 3, the shopping process is entered at 109 and access is provided to general information 110, virtual showroom 112, vehicle configurator 114, dealership locator 116 and payment options 118. The customer can access any or all of these phases in any order and can complete all or any part of the individual phases. The shopping process is exited at 119 directly from any one of the five phases.

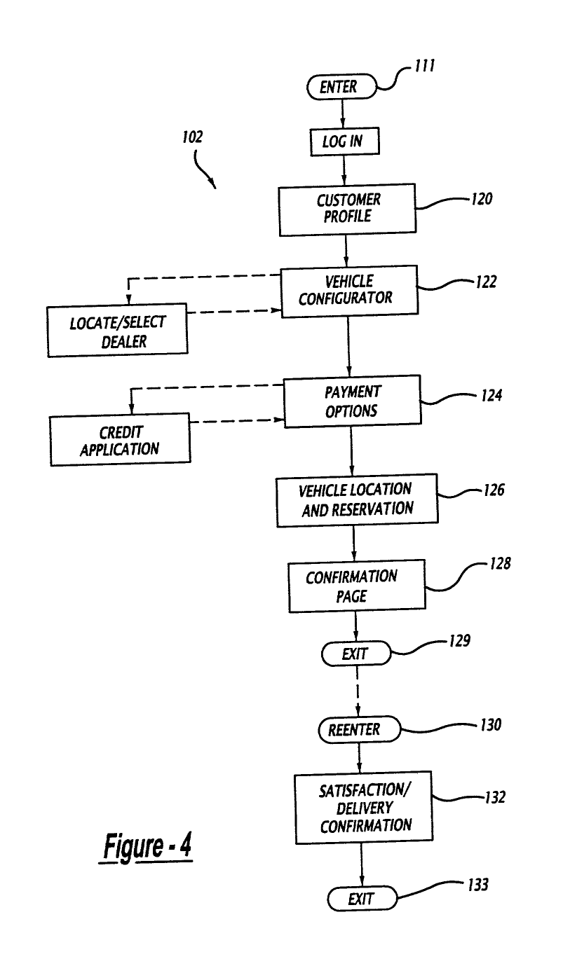

Within the buying process 102, the customer is directed down a required path that steps through the online purchase transaction. The website buying process is divided into six primary sequential phases (areas) with five of the six being required and proximate and the last being isolated by coming at a later time and being optional. As shown in FIG. 4, the website buying process is entered at 111 through a login process or directly to the customer profile 120. The process then moves on to the vehicle configurator 122, the payment options 124, vehicle location and reservation 126, and confirmation page 128 from where the customer exits 129 the process. At 130 the customer may re-enter the buying process 102 to provide requested input 132 on their satisfaction with the process and to confirm taking delivery of the vehicle. The customer then exits again at 133.

In addition to the primary phases of the shopping and buying process, a trade-in evaluation page is provided that includes text explaining how a user may obtain information to evaluate their used car. Links are included to provide information about the used car's value and the trade-in negotiation process. Other than the link, there is no integration with the other sites. If a link is selected, a pop-up window contains the new site with the subject site remaining open. The links provide options such as posting a vehicle to a bulletin board, estimating the vehicle's value or entering the vehicle in an auction. In addition, a link is provided to send an e-mail to the selected dealer to schedule a trade in evaluation.

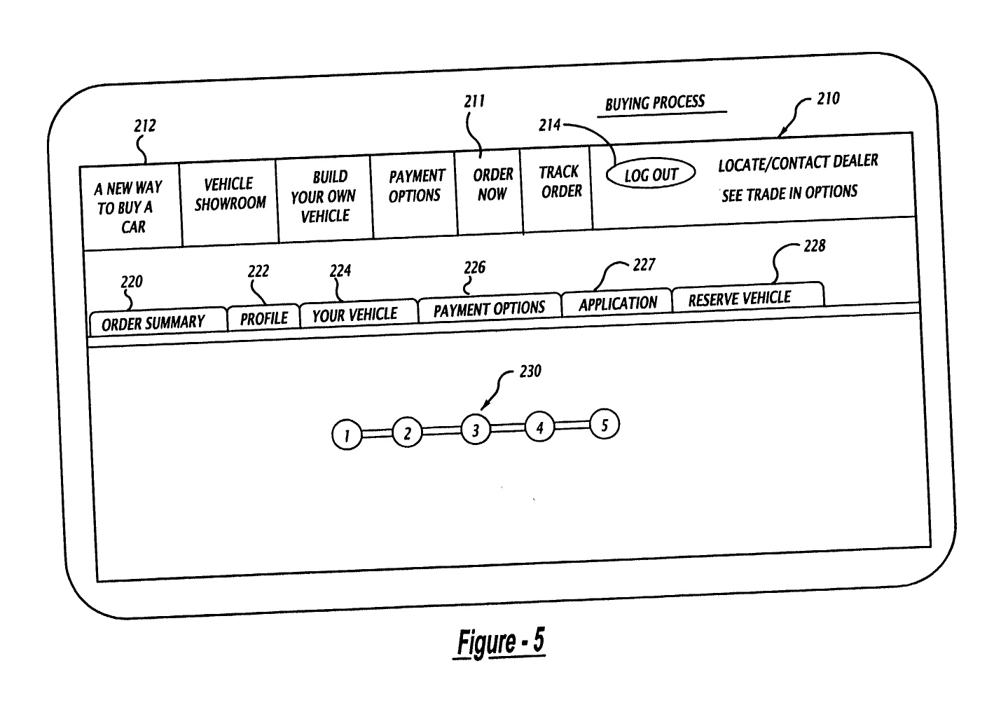

Returning to FIG. 2, general information about the manufacturing facility, the vehicle, and the online shopping and buying process is provided in the form of static pages 110. The general information includes a picture and statistics concerning the manufacturing facility, the vehicle and a description of the internet shopping and buying process. These pages are accessed via buttons provided on a site wide navigation bar 210 (FIG. 5). The button “a new way to buy a car” 212 provides a list of tabs for accessing the pages 110 which include information in text and visual illustration forms. A virtual vehicle showroom 112 is also accessed via a button on the navigation bar. Virtual showroom 112 provides dynamic pictures of the vehicle in 360° view, provides a color selection page that enables a customer to preview available colors in actual pictures of the vehicle, and provides an accessory simulator page with pictures displaying vehicles with each different combination of accessories. This page allows the customer to pick different options/accessories and to see the vehicle's appearance with them. A tab is also provided for accessing detailed information about the vehicle including available equipment, options and technical specifications.

Also in the shopping process 101, a vehicle configurator 114 provides customers with the capability to build their own vehicle, selecting color, options and accessories, while checking the price for each combination. By following the directions provided to complete a series of simple steps, the customer can configure a vehicle with the colors and options they choose. Once they have a vehicle configured according to their preference, they can review dealer accessories and services that can be purchased at the dealership when taking delivery of the vehicle. After configuring of their own vehicle, a customer has the choice of verifying if that configuration is available for purchase. If the customer has logged in with a user name and password the configuration can be saved for later reference and can be changed. The customer can also access the buying process at this time via a link to purchase the configured vehicle by clicking on the order now button 211.

Shopping customers have the capability to locate a dealer based on a city/state search, ZIP code search, or a name search through the dealership locator pages 116. Search results provide the customer with a list of nearest dealers along with location and contact information. The results also display a link for the customer to send an e-mail directly to the chosen dealer. The customer can contact the dealer for a test drive, trade in evaluation and other information.

The shopping process 101 also includes payment options pages 118. These pages give customers the ability to simulate financial plans for their choice of vehicle configurations including paying by cash, credit or financing. A side by side comparison of plans among all financing and leasing plans available is possible, with the customer inputting different down-payment amounts and choosing among available terms for each plan.

When the buying process is selected, such as by clicking on the order now button 211 in the navigation bar 210, the site will function differently depending on certain conditions. The first condition is whether the user is operating in a “logged in” mode. The login/logout status 214 is always displayed in the navigation bar with the text indicating the status of the user by offering the opposite of the actual current status. When the user logs out, the user's session data is cleared and they are returned to the home page. If the user is not logged in, when they enter the buying process a customer login page is displayed to allow the user to login as an identified user with a user name and password. If the user is logged in, the system will automatically check to see if the user has reserved a vehicle. If there is an order reserved for the vehicle, the user is taken to the track order section (described below). If the customer is logged in and does not have an order reserved, the user is taken to an order now section to enter the buying process.

The buying process 102 is divided in six primary sequential phases (areas). This section of the site includes six tabs (FIG. 5) that help in moving through the buying process including: order summary 220, profile 222, your vehicle 224, payment options 226, credit application 227, and reserve vehicle 228. The buying process is self sufficient and can be completed without use of the shopping process, but information resulting from any completed steps of the shopping process that is useful in the buying process is imported.

The order summary page is a type of checklist that helps the customer keep track of the steps that they must complete in order to reserve a vehicle and indicates which of the steps have already been processed and which have not been completed. The items in the checklist correspond to the five other tabs within the buying process area. A tracking tool 230 is also used and is a repetitive feature of the site that displays the steps a customer must complete to fulfill the requirements of a given part of the process or phase. Each of the numbered steps 1-5 are accompanied by descriptive text (not shown) and when a step has been completed the numbered ball in the tracking tool corresponding to that step is shaded with a colored fill.

The profile tab 222 provides a link to the profile page 120. At customer profile 120, personal customer information is required to complete the purchase of a vehicle. No personal customer information is displayed in the order summary. A customer number such as a driver's license number or other unique and reliable number is the identification key. A customer number can only be registered once in the website 10 and only one purchase per customer number at a time, is allowed. All of the input data is placed into tables in the hosting environment and replicated to legacy systems upon vehicle reservation. This information is used to fill out the invoice that is issued for the vehicle. The profile tab remains active allowing the customer to update their information at any time prior to submitting a credit application or reserving a vehicle. After either of those events only limited information may be changed such as the customer's phone number or e-mail address.

After completing the customer profile 120, the process moves on to vehicle configurator 122. The your vehicle tab 224 also provides a link to the vehicle configurator page 122, once the profile is completed. Before starting to configure a vehicle, customers must first indicate a preferred dealer for vehicle delivery. If the customer has selected a dealership during the shopping process, then that dealership can be used or a new search can be done. This search is based on the customer ZIP code and displays the closest dealer(s) based on latitude/longitude coordinates. The search also follows two other rules: all dealers in the same city of the informed ZIP code are shown first and, if customers want to see more dealerships, a second page displays all other dealerships in other ZIP codes but within a limit of 50 kilometers. Customer information, that was provided by the customer in the customer profile area 120, is checked against a table with all ZIP codes for the country. Each ZIP code in the mentioned table has a correspondent latitude and longitude coordinate. These coordinates are then cross-checked with another table that has all dealerships with the respective latitude and longitude coordinate. The closest dealer is shown first, followed by the second closest and so on. If the customer is using a kiosk at a dealership, the locate a dealer step is not necessary and the system defaults to the dealership housing the kiosk. In this case, a message is displayed informing the customer that the dealer they are currently at will be the delivery location for their vehicle.

After having selected a dealership, the customer can select the model, color, options and accessories for their vehicle and review the price. The steps indicated by the tracking tool 230 for the pages involved in this part of the process include: 1. Select Color, 2. Select Options, 3. Review Final Vehicle Price, 4. Dealer Accessories, and 5. Summary. If the vehicle configurator step has already been completed as part of the shopping process or once completed, the delivery location and vehicle configuration are displayed in the order summary.

The price for a configured vehicle (selected model, color and options), is displayed by the summary page and must be paid to before taking delivery of the vehicle. Prices for dealer accessories are displayed as manufacturer suggested retail prices (MSRP) and do not include the manpower for installation. The price for dealer installed accessories is paid to the dealer of delivery.

Moving on in the process, after vehicle configuration is complete, a customer is requested to select a payment option 124 from a list that includes: cash, finance, leasing, or using credit. The payment options tab 226 also provides a link to the payment options pages 124, once the vehicle configurator step is complete. The tracking tool for this part of the site varies depending on the option selected. For example, the steps for paying by cash include: 1. Review Costs and 2. Calculate total price. The steps for financing include: 1. Review Costs, 2. Select Financing Option, 3. Other Additions and 4. Summary.

The customer may request a side-by-side comparison of up to two different plans at a time, providing a means through which the client can simulate different plans, down-payment amounts and terms. GM Card (promotional award credit card) points are also input in this stage with the allowable amount being deductible from the total vehicle price. The customer is presented with a web page requesting the information only if the customer chooses to apply GM card points to the purchase by clicking on a button. The customer is also given the opportunity to include credit life and automobile insurance in the monthly payment when financing or leasing. These items are considered “other additions” under Step 3 mentioned above. When the payment options step is completed, the type of payment means and amount due are displayed in the order summary.

If the customer is seeking credit approval for financing or leasing, he/she is given the opportunity to fill out an express application form and submit it online. The application tab 227 also provides a link to submit an express application once the payment options step has been completed and the customer has selected financing to pay for the vehicle. If the customer is not financing then this step is not available. An input screen is provided to gather customer information necessary to determine credit worthiness. Fields are pre-populated with available customer session and stored data such as that submitted during the profile stage 120. Pre-populating is made possible by session management which allows information collected in one component to be shared with other components. This eliminates the need for the customer to supply the same information at multiple locations in the site. A connection with an online scoring system permits a quick credit check and feedback to the customer. The text in the application tab 227 changes to “financing status,” once the application has been completed and submitted, permitting the customer a link via the tab to view the status of their credit application. If any deficiency is found as a result of the express application and automatic credit approval can't be granted, a message is automatically generated and passed an to analysts for manual follow-up. After reservation, all financial related information is replicated to the legacy systems feeding the accounting and financing functions, among others.

After filling-in personal data, selecting a dealer, building his/her preferred configuration and choosing the way to pay for it, the customer can locate the desired vehicular unit via the vehicle location and reservation step 126. The reserve vehicle tab 228 also provides a link to the vehicle location and reservation page 126. This link is only enabled when the steps 120, 122 and 124 have been completed and the customer has been pre-approved, if financing. First, the customer must review their order information and confirm its accuracy by clicking on a button that also initiates the vehicle search. An exact match is sought from inventory. Upon location, this matching unit is assigned to that customer, and prevented from being located by any other customer, temporarily at this point for a preferred period of time such as 15 minutes. During this timeframe, the customer is asked to finalize his/her reservation by paying the reservation fee. If the customer fails to complete reservation by paying the reservation fee during the 15 minute period, the car becomes available to other customers again.

The location process is conducted directly in the available inventory that consists of all vehicles available in the distribution centers 20 plus all vehicles in transit to the distribution center 20 that are assigned to the selected dealership 30, plus all vehicles available at the manufacturing facility 12. The results of the location search display the exact match for the selected vehicle configuration with an estimated delivery date, factoring in the dealer selected by the customer. If near match vehicles with an earlier delivery date are available, they are displayed as alternative vehicles from which the customer may choose and the earlier estimated delivery date are shown. If no exact match is found, alternative vehicles with the closest configuration are displayed, when available. If no exactly or closely matching vehicle is available, a page displaying this information is shown and the customer is also given the option of being placed on a wait list for the vehicle they have configured when an exact match is not available.

The wait list is organized by vehicle configuration and by date/time of a customer's entry. As vehicles are released from production, the wait list customer that selected the configuration with an earlier date/time are automatically assigned a pre-reservation first. When assigned such a pre-reserved vehicle, a customer has a fixed deadline to complete reservation. If reservation is not complete within the given timeframe, the vehicle is released for pre-reservation to the next customer on the wait list, if any, or distributed normally.

To complete the reservation, the reservation fee, the entire amount for the vehicle (when paying cash) or the whole down payment (when financing/leasing) must be paid. When the buying process is being conducted from a dealer kiosk, the customer may pay the reservation fee with a credit card, cash, or a check delivered to the dealer who must confirm the receipt of funds by entering the information via the website. When the customer is conducting the buying process from any other computer, the reservation fee may be paid by credit card.

Upon finalizing a reservation, the customer receives a confirmation page 128 which has buttons to print a receipt, bank slips for payments, a contract, and any other applicable documentation required. The confirmation page identifies the vehicle, payment, dealer and other transaction-related information, including credit card transaction ID. If the reservation fee is paid using a credit card, the confirmation page brings additional information including a receipt that can be printed by customer. The customer is informed that they may follow their order in the “track order” section. The transaction is confirmed and the next step necessary is to assure delivery at dealership.

With confirmation, the customer exits the buying process 102 at 129 and information about the customer, vehicle and payment are replicated to legacy systems feeding accounting, invoicing, logistics, distribution, and others. The complete linkage with legacy systems allows the manufacturer to take vehicle orders without the manual work of locating a vehicle or confirming estimated delivery date. Location is done online and assures that one located unit will be available for reservation for that customer. Replication processes ensure that all information is transmitted to the specific mainframe based system. Invoicing, Payment Control, Distribution, and Logistics are all prepared to receive correspondent information from the web site and process it, taking forward the purchase until the vehicle is delivered.

The vehicle is marked as reserved for that given customer and all necessary steps for vehicle delivery at the dealer begin. On the web side, the customer now gains the ability to enter the “track order” section. They can confirm personal data, review the components of their order, review chosen payment type, financial approval status, selected accessories, trace payment due information and check delivery status. The customer's phone number and e-mail address may be updated in the personal profile. The specific vehicle configuration that was reserved by the customer cannot be changed at this point. The payment section allows the customer to view the status of payments that have already been made, and also view the amount of any outstanding payments and the date by which they must be made. A delivery status section provides information on the location of delivery, expected date of delivery to the dealer, the present location of the vehicle and any messages that may have been sent to the customer.

Paying the balance of the vehicle's price in excess of the reservation fee (the final payment or down payment with financing/leasing), may be made by cash or check or by transfer from an established account or line of credit when operating from a kiosk at a dealership. From other computers the customer may pay the balance due by transfer via an established account or line of credit from a cooperating lender. The process is completely online, with the customer inputting their account id and password to authorize the transaction. Paying from an established credit line exempts the customer from paying a separate reservation fee. Also, if the credit line amount established with the cooperating lender is either higher or lower the purchase than amount, the system will automatically calculate the balance and provided options for paying amounts due or start the process for returning the extra amount.

If the final or down payment process is executed at a dealership, the following sequence of events occurs: 1. the customer goes to the delivering dealership, 2. the customer enters the final or down payment page of their track order section of the web site from the dealer's kiosk, 3. the customer fills out the page, 4. the customer then presents the check or cash to the dealership representative, 5. the dealership representative enters their ID and password on the track order final or down payment page and submits to verify receipt of the payment, 6. the status of the vehicle changes from reserved to ready for delivery (for the final payment).

When the customer elects to make their final or down payment at their bank, the following sequence of events occurs: 1. the customer enters the web site and proceeds to their track order section of the site. 2. the customer prints a bank slip, 3. the customer takes the bank slip to their bank and makes a payment and receives a receipt, 4. the customer takes the bank receipt to the dealership where they enter the final or down payment page within their track order section of the web site, 5. the customer fills out the page, 6. the customer then presents the bank receipt to the dealership representative, 7. the dealership representative enters their ID and password on the track order final or down payment page and submits to verify receipt of the payment, 8. the status of the vehicle changes from reserved to ready for delivery (for the final payment).

When all payments are entered and cleared and the vehicle is at the dealership with an “ok to delivery” flag, the customer is requested to reenter the web based process at 130 to answer 3 questions regarding satisfaction with the process at 132 and to confirm taking delivery of their vehicle before re-exiting the buying process at 133. This section is only available when the following conditions are met: 1. the vehicle has been delivered to the dealer, 2. if financing, all documentation and final approval has been completed, 3. the final/down payment has been cleared, and 4. the customer is accessing the site from the delivering dealer's kiosk. After filling out the short survey and clicking the submit button, a delivery receipt page is displayed that can be printed. The submission of the customer's survey also sends notification triggering the commission payment to the dealer. Once the customer submits the survey, the order is considered complete and it is no longer available via the track order button. At this time the customer becomes eligible to initiate a new order by entering the buying process.

Thus, an automotive shopping and buying system and method is provided that includes a complete online sales experience, from selecting the desired configuration through paying the reservation fee and taking delivery of the vehicle. The only required offline process is the trip to the selected dealer to take delivery of the vehicle.

1. A shopping and buying system comprising:
an internet accessible computer data base having information regarding vehicles for sale;
application software including a routine permitting the selection of specific data from the data base based upon inquiries from a customer;
the application software receiving data input from the customer requesting a vehicle search of the data base for a vehicle configuration prepared by the customer wherein the search results identify a particular vehicle located at one of a manufacturing facility, a distribution center, or in shipment between the manufacturing facility and the distribution center;
the application software notifying the customer of a delivery location consisting of a dealership and a delivery time of the particular vehicle; and
wherein the particular vehicle is delivered to the dealership for the customer to take delivery of the particular vehicle.

2. A shopping and buying system according to claim 1 wherein the application software is accessed by the customer via a website and wherein after the customer has taken delivery of the particular vehicle, the customer accesses the website to submit data regarding their satisfaction with the shopping and buying process and to confirm delivery of the particular vehicle.

3. A shopping and buying system according to claim 1 wherein when the particular vehicle is identified it is associated with the customer and is not available to other customers for a period of time that is temporarily unless the customer pays a reservation fee.

4. A shopping and buying system according to claim 3 wherein the period of time is approximately fifteen minutes.

5. A shopping and buying system according to claim 1 wherein the database is supplied with information by the manufacturing facility, the distribution center, the dealership and the customer.

6. A shopping and buying system according to claim 1 wherein the application software is accessed by the customer via a website includes a number of first pages devoted to general information about the vehicle and the manufacturing facility, a number a second pages devoted to a virtual showroom of the vehicle, a number of third pages devoted to configuring a vehicle according to the customers specifications, a number of fourth pages devoted to locating a dealership, and a number of fifth pages devoted to options of paying for the vehicle.

7. A shopping and buying system according to claim 6 wherein the customer may access the first, second, third, fourth and fifth pages in an order preferred by the customer and in any combination.

8. A shopping and buying system, according to claim 1 wherein before the search is initiated for vehicle configuration prepared by the customer, the customer must submit a customer profile to the database and select a method of paying for the vehicle.

9. A method conducted using the shopping and buying system of claim 1 and comprising:
entering a buying process routine of the application software;
submitting a customer profile to the database;
configuring a vehicle by combining available options from the database;
locating and selecting a dealership for delivery of the configured vehicle;
selecting a method of paying for the configured vehicle from a list of available payment options
after selecting a method of paying for the configured vehicle, locating a particular vehicle matching the configuration;
reserving the particular vehicle; and
delivering the reserved vehicle to the selected dealership.

10. A method according to claim 9 wherein selecting a method of paying for the configured vehicle includes submitting a credit application to the database and apprising the customer of the status of the submitted credit application.

11. A method according to claim 9 wherein the dealership must be selected before the vehicle is configured.

12. A method comprising:
providing a database accessible via a website;
providing a number of website shopping pages devoted to shopping for a product including information about the product and including application software for locating a dealership and configuring a product;
providing a number of website buying pages devoted to buying the product wherein data corresponding to the dealership located in the shopping pages is transmitted to the buying pages by the application software and data corresponding to the product configured in the shopping pages is transmitted to the buying pages by the application software so that duplicate entry of data is not required.

13. A method comprising:
entering buying process pages of a website to purchase a product;
submitting a customer profile including required information about a particular customer;
preparing a product configuration from available options and accessories according to the preferences of the customer;
locating a dealership for delivery of a particular product acceptably matching the product configuration;
selecting a method of paying for the particular product from a list of available payment options;
locating the particular product from available products;
reserving the located particular product;
confirming reservation of the located particular product;
informing the customer of the place and time of delivery of the located particular product; and
delivering the located particular product to the customer at the informed place and time.

14. A method according to claim 13 wherein when the particular product is located from available products the particular product is an exact match to the product configuration.

15. A method according to claim 14 wherein the located product is identified in search results communicated to the customer along with alternate products that are not an exact match to the product configuration but are available for delivery at a time that is sooner than a time that the particular product is available for delivery.

16. A method according to claim 13 wherein the available products do not include an exact match to the configured product and wherein the customer is informed that an exact match is not available.

17. A method according to claim 16 wherein the customer is informed of search results that present alternate products that are close to matching the configured product and are available.

18. A method according to claim 16 including informing the customer that their name may be placed on a wait list for the configured product.

19. A method according to claim 14 including removing the particular product from availability to other customers for a temporary period and making the particular product available to other customers at the expiration of the temporary period if the customer fails to pay a reservation fee.

20. A method according to claim 13 including entering information concerning the customer's satisfaction with the purchase of the product via the website.

21. A method according to claim 13 wherein selecting a method of paying for the particular product includes submitting a credit application via the website and apprising the customer of status of the credit application wherein the page identified with the credit application includes a tab entitled application before submission of the application and entitled status after submission of the application.

22. A method according to claim 13 wherein selecting a method of paying for the particular product includes submitting information about accrued points that are applied toward a purchase price of the product.

23. A method according to claim 13 wherein configuring the product includes selecting options that are added to the product by a manufacturer of the product and selecting accessories that are added to the product by a dealership that sells the product.

24. A method according to claim 13 wherein locating a dealership includes submitting information concerning a location of the customer and selecting a list of available dealerships including a dealership closest to the location of the customer.

25. A method according to claim 13 wherein configuring a product included limiting the number of configured products to one for each customer profile that is associated with a configured product that is reserved and undelivered.
